(19) United States
(12) Patent Application Publication
(10) Pub. No.: US 2022/0343613 A1
(43) Pub. Date: Oct. 27, 2022

(54) METHOD AND APPARATUS FOR VIRTUALLY MOVING REAL OBJECT IN AUGMENTED REALITY

(71) Applicant: ELECTRONICS AND TELECOMMUNICATIONS RESEARCH INSTITUTE, Daejeon (KR)

(72) Inventors: Yong Sun Kim, Daejeon (KR); Hyun Kang, Daejeon (KR); Kap Kee Kim, Daejeon (KR)

(73) Assignee: ELECTRONICS AND TELECOMMUNICATIONS RESEARCH INSTITUTE, Daejeon (KR)

(21) Appl. No.: 17/725,126

(22) Filed: Apr. 20, 2022

(30) Foreign Application Priority Data
Apr. 26, 2021 (KR) 10-2021-0053648

(51) Int. Cl. G06T 19/20; G06T 19/00; G06T 5/00

(52) U.S. Cl. CPC G06T 19/20; G06T 19/006; G06T 5/002; G06T 2219/2021; G06T 2207/20084; G06T 2219/2016

(57) ABSTRACT

Disclosed is a method for moving a real object in a 3D augmented reality. The method may include: dividing a region of the real object in the 3D augmented reality; generating a 3D object model by using first information corresponding to the region of the real object; and moving the real object on the 3D augmented reality by using the 3D object model.

### CROSS-REFERENCE TO RELATED APPLICATION

This application claims priority to and the benefit of Korean Patent Application No. 10-2021-0053648 filed in the Korean Intellectual Property Office on Apr. 26, 2021, the entire contents of which are incorporated herein by reference.

### cl BACKGROUND OF THE INVENTION

### (a) Field of the Invention

The present disclosure relates to a method and an apparatus for virtually moving a real object in an augmented reality.

### (b) Description of the Related Art

An existing augmented reality may provide additional information in addition to a virtual object to an image of a real environment or provide an interaction between the virtual object and a user. A 2 dimensional (D) augmented reality shows a virtual image or an image acquired by rendering the virtual object in addition to a camera image. In this case, information on the real environment in the image is not utilized, and the virtual image is simply added to the real environment, so screening between a real object and the virtual object is not reflected and a difference sense for a spatial sense, etc., is generated. Meanwhile, since a 3D augmented reality expresses the screening phenomenon between the real object and the virtual object by rendering the virtual object on a 3D space, the difference sense between the real object and the virtual object may be reduced. However, even in the existing 3D augmented reality, only the interaction between the virtual object and the user is possible in a fixed environment for the real object.

As one example, in furniture layout contents using the augmented reality, plane or depth information for the real environment is extracted and a virtual furniture is arranged on a background having the plane or depth information. The user can change a location of the virtual furniture or rotate the virtual furniture, but even in this case, only the interaction between the user and the virtual furniture is possible without the interaction for a real furniture. As a result, various experiences such as replacing or arranging the real furniture are impossible.

As such, the existing augmented reality additionally shows the virtual object to the real environment, and only the interaction between the virtual object and the user is performed. In a new augmented reality, the interaction between the real object and the virtual object is required. It is necessary that the user also performs the interaction for all without distinguishing the real object and the virtual object such as removing or moving and manipulating the real object on the augmented reality.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a method and an apparatus for virtually moving a real object in an augmented reality.

An exemplary embodiment of the present disclosure may provide a method for moving, by an apparatus for moving a real object, the real object in a 3D augmented reality. The method may include: dividing a region of the real object in the 3D augmented reality; generating a 3D object model by using first information corresponding to the region of the real object; and moving the real object on the 3D augmented reality by using the 3D object model. The first information may be 3D information and texture information corresponding to the region of the real object.

The generating may include estimating a 3D shape for an invisible region for the real object by using the 3D information, and generating the 3D object model by using the texture information and the 3D shape. The method may further include synthesizing a region at which the real object is positioned before moving by using second information which is surrounding background information for the region of the real object.

The synthesizing may include deleting the region of the real object in the 3D augmented reality, and performing inpainting for the deleted region by using the second information.

The synthesizing may further include estimating a shade region generated by the real object, and the deleting may include deleting the region of the real object and the shade region in the 3D augmented reality.

The second information may be 3D information and texture information for a surrounding background for the region of the real object.

The estimating may include estimating the 3D shape by using the 3D information through a deep learning network constituted by an encode and a decode. The performing of the inpainting may include performing the inpainting for the deleted region by using the second information through a deep learning network constituted by a generator and a discriminator.

The method may further include selecting, by a user, the real object to be moved in the 3D augmented reality. Another exemplary embodiment of the present disclosure provides an apparatus for moving a real object in a 3D augmented reality. The apparatus may include: an environment reconstruction thread unit performing 3D reconstruction of a real environment in for the 3D augmented reality; a moving object selection unit being input from the user with a moving object which is a real object to be moved from a 3D reconstruction image; an object region division unit dividing a region corresponding to the moving object in the 3D reconstruction image; an object model generation unit generating a 3D object model for the divided moving object; and an object movement unit moving the moving object in the 3D augmented reality by using the 3D object model. The object model generation unit may generate the 3D object model by using 3D information and texture information corresponding to the divided moving object.

The object model generation unit may estimate a 3D shape for an invisible region for the moving object by using the 3D information, and generate the 3D object model by using the texture information and the 3D shape.

The apparatus may further include an object region background synthesis unit synthesizing a region at which the moving object is positioned before moving by using surrounding background information corresponding to the divided moving object.

The object region background synthesis unit may delete the region corresponding to the moving object, and perform inpainting for the deleted region by using the surrounding background information.

The object region background synthesis unit may estimate a shade region generated by the moving object, and delete the region corresponding to the moving object and the shade region in the 3D augmented reality.

The object region background synthesis unit may include a generator being input with the 3D reconstruction image including the deleted region, and outputting the inpainted image, and a discriminator discriminating an output of the generator.

The apparatus may further include: an object rendering unit rendering the 3D object model; and a synthesis background rendering unit rendering the synthesized region.

The object model generation unit may include a 2D encoder being input with the 3D information and outputting a shape feature vector, and a 3D decoder being input with the shape feature vector and outputting the 3D shape.

According to at least one exemplary embodiment of exemplary embodiments, a real object is moved upon experiencing an augmented reality to provide an interaction between a user and the real object.

In addition, according to at least one exemplary embodiment of exemplary embodiments, the real object is moved, and then synthesized by using surrounding background information to arrange a virtual object as if the real object is not originally present.

### BRIEF DESCRIPTION OF THE DRAWINGS

FIG. 1 is a block diagram illustrating a real object moving apparatus according to one exemplary embodiment.

FIG. 2 is a flowchart illustrating a 3D object model generating method for a moving object according to one exemplary embodiment.

FIG. 3 is a diagram illustrating a deep learning network structure for estimating a 3D shape according to one exemplary embodiment.

FIG. 4 is a flowchart illustrating a method for synthesizing a moving object region.

FIG. 5 is a diagram illustrating a deep learning network structure for inpainting according to one exemplary embodiment.

FIG. 6 is a conceptual view for a schematic operation of a real object moving apparatus according to one exemplary embodiment.

FIG. 7 is a diagram illustrating a computer system according to one exemplary embodiment.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise”, and variations such as “comprises” or “comprising”, will be understood to imply the inclusion of stated elements but not the exclusion of any other elements.

Hereinafter, a method and an apparatus for virtually moving a real object in an augmented reality according to exemplary embodiments of the present disclosure will be described in detail. Hereinafter, a terminology ‘apparatus for virtually moving real object in augmented reality’ is used mixedly with a terminology ‘real object moving apparatus’, and a terminology ‘method for virtually moving real object in augmented reality’ is used mixedly with a terminology ‘real object moving method’.

The real object moving method according to the exemplary embodiment may reconstruct 3D information of a real object to be moved and generate a 3D model based on 3D information (e.g., depth information) for a real environment.

The real object viewed through a camera has depth information for a visible region, but there is no information on an invisible region (e.g., a back of an object) which is not visible through the camera. As a result, the real object moving method according to the exemplary embodiment estimates and reconstructs the 3D information of the invisible region based on the 3D information of the visible region. The real object moving method according to the exemplary embodiment generates the 3D model of the object by using the reconstructed 3D information and color image information. In addition, in the real object moving method according to the exemplary embodiment, the generated 3D model may be regarded as the virtual object, manipulations such as movement, rotation, etc., may be performed, and the augmented reality may be implemented through rendering.

Meanwhile, when the real object is moved in the augmented reality, the real object needs to be deleted from the image and a location where the real object is present needs to be changed to a background. To this end, in the object moving method according to the exemplary embodiment, a deleted real object part may be changed to the background by performing inpainting the real object region. That is, in the object moving method according to the exemplary embodiment, a corresponding object region is deleted by using the 3D information (depth information) and a texture (color image) for a region corresponding to the real object, and the deleted region is inpainted and synthesized through a depth and a color of a surrounding background. In addition, the object moving method according to the exemplary embodiment, the synthesized background is rendered to achieve an effect that the real object is virtually moved, and then deleted from an original location.

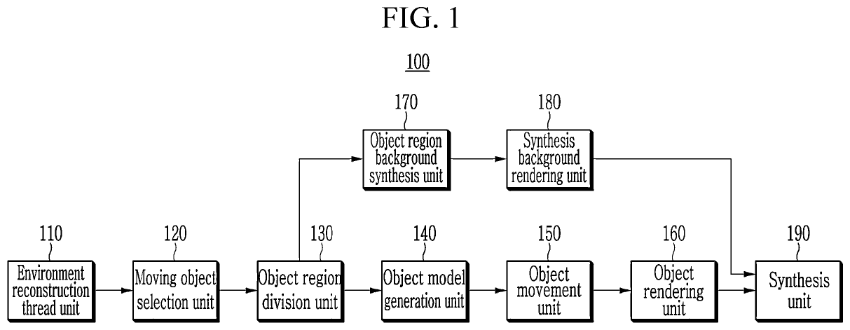

FIG. 1 is a block diagram illustrating a real object moving apparatus 100 according to one exemplary embodiment.

As illustrated in FIG. 1, the real object moving apparatus 100 according to one exemplary embodiment may include an environment reconstruction thread unit 110, a moving object selection unit 120, an object region division unit 130, an object model generation unit 140, an object movement unit 150, an object rendering unit 160, an object region background synthesis unit 170, a synthesized background rendering unit 180, and a synthesis unit 190.

The environment reconstruction thread unit 110 performs 3D reconstruction of the real environment. A method in which the environment reconstruction thread unit 110 implements a 3D reconstruction, i.e., 3D augmented reality corresponding to the real environment may be known by those skilled in the art, so a detailed description thereof will be omitted. For the 3D augmented reality, 6 degree of freedom (DOF) tracking for estimating a camera posture may also be performed in real time. The 6DOF tracking may be performed by a camera tracking thread unit (not illustrated), and the camera tracking thread unit performs the 6DOF tracking through multi-threading. Here, the 3D augmented reality reconstructed by the environment reconstruction thread unit 110 includes 3D information indicating the depth information and texture information indicating the color information. That is, the environment reconstruction thread unit 110 may output the 3D information and the texture information. Meanwhile, the 3D information may be expressed as PointCloud or Voxel. In the following exemplary embodiment, a depth image in which information of 3D points is projected to a 2D image coordinate, such as PointCloud or Voxel may also be used jointly.

The moving object selection unit 120 is input with the moving object from the user. Here, the moving object is a part corresponding the real object to be moved in the 3D augmented reality and the real object to be moved is selected by a user. That is, the user selects the real object to be moved in the 3D augmented reality. Hereinafter, for convenience, the real object to be moved, which is selected by the user will be referred to as ‘moving object’. The object region division unit 130 divides the moving object input from the moving object selection unit 120 in the 3D augmented reality. The divided moving object includes the 3D information and the texture information corresponding the moving object. Here, when the user does not satisfy the moving object divided by the object region division unit 130 by viewing the divided moving object, the user may perform interactive segmentation by adding points in the moving object region and a point in the background region other than the object. As a method for dividing the moving object in the 3D augmented reality, the following method may be used. The object region division unit 130 divides the region of the moving object selected by the user in a 2D color image (texture information). In addition, the object region division unit 130 performs separation of a foreground and the background on 2D and 3D by using a 2D and 3D relationship to divide the region of the moving object even on the 3D.

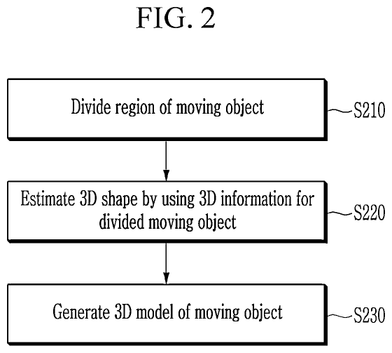

The object model generation unit 140 generates the 3D object model for the moving object divided by the object region division unit 130. Information (i.e., the 3D information and the texture information of the moving object) for the moving object divided by the object model generation unit 140 is data regarding the visible region viewed through the camera. As a result, the object model generation unit 140 estimates 3D information for the invisible region of the object which is not obtained through the camera, such as the back of the moving object or a part hidden by another object, and generates a full 3D mesh/texture model for an outer shape of the moving object. A method in which the object model generation unit 140 generates the 3D object model for the moving object will be described in more detail in FIG. 2 below. The object movement unit 150 performs movement, rotation, etc., for the moving object in the augmented reality in response to the manipulation of the user by using the 3D object model generated by the object model generation unit 140. That is, since the object movement unit 150 generates the 3D object model for the moving object, the object movement unit 150 may arbitrarily perform movement and rotation by regarding the moving object as the virtual object.

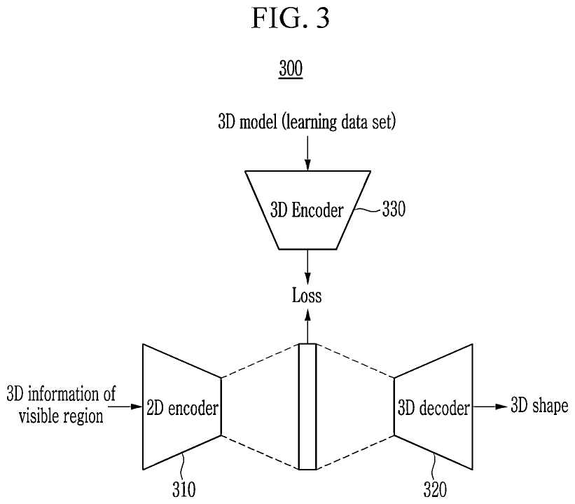

The object rendering unit 160 may render the 3D object model and express the rendered 3D object model in the augmented reality when the object movement unit 150 moves the moving object in the augmented reality. Here, information from the camera tracking thread unit, i.e., direction information viewed by the camera may be used at the time of rendering the 3D object model. A method for rendering the 3D object model and implementing the rendered 3D object model in the augmented reality may be known by those skilled in the art in the technical field to which the present disclosure belongs, so a detailed description will be omitted. Meanwhile, the object region background synthesis unit 170 deletes a region corresponding to the moving object divided by the object region division unit 130 from the background, and performs inpainting for the deleted region by using surrounding background information. On an augmented reality screen, even though the moving object is virtually moved, the moving object is still viewed in an input image. As a result, in the exemplary embodiment, in the image input when the moving object is virtually moved, a region where the real object (i.e., moving object) is present is synthesized by a surrounding background. Through this, an effect that the moving object is perfectly moved in the augmented reality may be achieved. A detailed operation of the object region background synthesis unit 170 will be described in more detail in FIG. 3 below.

The synthesis background rendering unit 180 performs rendering for the inpainted part with the surrounding background information by the object region background synthesis unit 170. Here, the information from the camera tracking thread unit, i.e., the direction information viewed by the camera may be used at the time of rendering the inpainted part.

In addition, the synthesis unit 190 implements the 3D augmented reality in which the real object is finally moved by synthesizing the moving object rendered by the object rendering unit 160 and the background rendered by the synthesis background rendering unit 180.

FIG. 2 is a flowchart illustrating a 3D object model generating method for a moving object according to one exemplary embodiment. That is, FIG. 2 illustrates a method for generating, by the object model generation unit 140, the 3D object model of the moving object by estimating the 3D information for the invisible region by using the data of the visible region viewed through the camera.

First, the object region division unit 130 divides the region of the moving object corresponding to the moving object selected by the user in the 3D augmented reality (S210). Here, the divided moving object may include the 3D information and the texture information.

The object model generation unit 140 estimates a 3D shape by using the 3D information for the moving object divided in S210 (S220). The 3D information for the moving object divided in S210 is 3D data for the visible region viewed by the camera. As a result, the object model generation unit 140 outputs a total 3D shape by estimating the 3D shape for the invisible region by using the 3D data for the visible region. For example, when the 3D information for the moving object is PointCloud, the object model generation unit 140 may output the total 3D shape by estimating the 3D shape for the invisible region of the moving object by using PointCloud of the visible region. For estimating the 3D shape, an Autoencoder, which is one of the methods based on deep learning, may be used. That is, the object model generation unit 140 may be implemented in a deep learning network structure for estimating the 3D shape. FIG. 3 is a diagram illustrating a deep learning network structure 300 for estimating a 3D shape according to one exemplary embodiment.

As illustrated in FIG. 3, the deep learning network structure 300 according to one exemplary embodiment may include a 2D encoder 310 and a 3D decoder 320. In addition, the deep learning network structure 300 may further include a 3D encoder 330 for pre-learning. The deep learning network structure 300 of FIG. 3 may be pre-learned through three steps.

As a first step, the 3D encoder 330 and the 3D decoder 320 are learned through a learning data set for a 3D model. The 3D encoder 330 serves to be input with the learning data set of the 3D model to describe a feature of a shape. As a result, the 3D encoder 330 outputs a shape feature vector. In addition, the 3D decoder 320 is input with the shape feature vector output from the 3D encoder 330 to output the 3D shape (3D shape model).

As a second step, the 2D encoder 310 is input with 3D information (i.e., a learning data set including only the visible region) of the vision region for learning, and outputs the shape feature vector. In this case, the 2D encoder 310 is learned so that the shape feature vector output from the 2D encoder 310 is similar to the shape feature vector output from the 3D encoder 330.

As a third step, the 2D encoder 310 and the 3D decoder 320 are learned. The shape feature vector output from the 2D encoder 310 is input into the 3D decoder 320 and the 3D decoder 320 outputs 3D shape information (e.g.,

PointCloud or Voxel).

In the deep learning network structure 300 learned as such, 3D information (data) for the visible region to be estimated is input as an input of the 2D encoder 310. The 2D encoder 310 generates the shape feature vector for the input 3D information (the 3D information for the visible region), and outputs the generated shape feature vector to the 3D decoder 320. The 3D decoder 320 is input with the shape feature vector output from the 2D encoder 310, and finally outputs the 3D shape (3D shape information) of the moving object in which the invisible region is estimated. The object model generation unit 140 generates the 3D model of the moving object based on the 3D shape estimated in step S220 and the texture information of the divided moving object (S230). That is, the object model generation unit 140 soundly generates the 3D model of the moving object by using PointCloud completed in step S220 and the texture information of the moving object in step S210.

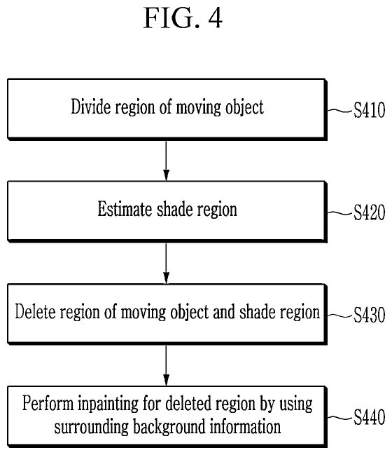

FIG. 4 is a flowchart illustrating a method for synthesizing a moving object region. That is, FIG. 4 illustrates a method for synthesizing, by the object region background synthesis unit 170, a background region screened by the object (moving object).

First, the object region division unit 130 divides the region of the moving object corresponding to the moving object selected by the user in the 3D augmented reality (S410). Here, the divided moving object may include the 3D information and the texture information. When a shade is generated by the moving object divided in step S410, the object region background synthesis unit 170 estimates a corresponding shade region (S420). When the moving object is moved from an original location, a natural synthesis background may be acquired only by removing the shape of the moving object jointly. As a result, the object region background synthesis unit 170 estimates the shade region generated by the moving object.

As a method for estimating the shade region, a method similar to an existing Mask R-CNN method may be used. As one example, a thesis ‘Instance Shadow Detection (Tianyu Wang, Xiaowei Hu, etc.)’ may be used. A detailed method thereof may be known by those skilled in the art in the technical field to which the present disclosure belongs, so a detailed description will be omitted.

The object region background synthesis unit 170 deletes the region of the moving object divided in step S410 and deletes the shade region estimated in step S420 (S430). The object region background synthesis unit 170 deletes the texture information (color information) corresponding to the region of the moving object divided in step S410 and the texture information (color information) corresponding to the shade region estimated in step S420 from the 3D augmented reality. In addition, the object region background synthesis unit 170 deletes the 3D information (i.e., depth information) corresponding to the region of the moving object divided in step S410 from the 3D augmented reality.

The object region background synthesis unit 170 performs inpainting for the region deleted in step S430 by using surrounding background information (S440). That is, the object region background synthesis unit 170 performs inpainting (filling) for the deleted region by using the surrounding background information (including both the texture information and the 3D information) for the region deleted in step S430. Here, a deep learning network may be used for the inpainting method using the surrounding background information.

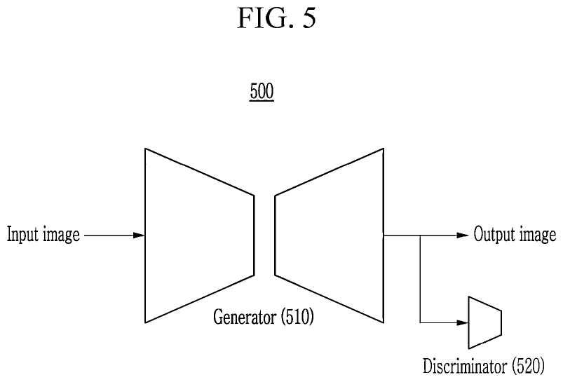

FIG. 5 is a diagram illustrating a deep learning network structure 500 for inpainting according to one exemplary embodiment. The object region background synthesis unit 170 may perform the inpainting for the deleted region by using the deep learning network structure 500 illustrated in FIG. 5. The deep learning network structure 500 according to one exemplary embodiment includes a generator 510 and a discriminator 520. That is, the object region background synthesis unit 170 may include the generator 510 and the discriminator 520. An image (i.e., surrounding background information) including the region deleted in step S430 is input into the generator 510, and the generator 510 outputs an image with which the deleted region is synthesized (inpainted). That is, an input image of the generator 510 as the surrounding background information to which the deleted region is reflected includes the 3D information and the texture information. Here, the discriminator 520 discriminates whether the generator 510 synthesizes a plausible image to allow the generator 510 to synthesize the plausible image which exists in a real world. Detailed operations of the generator 510 and the discriminator 520 may be known by those skilled in the art in the technical field to which the present disclosure belongs, so a detailed description will be omitted.

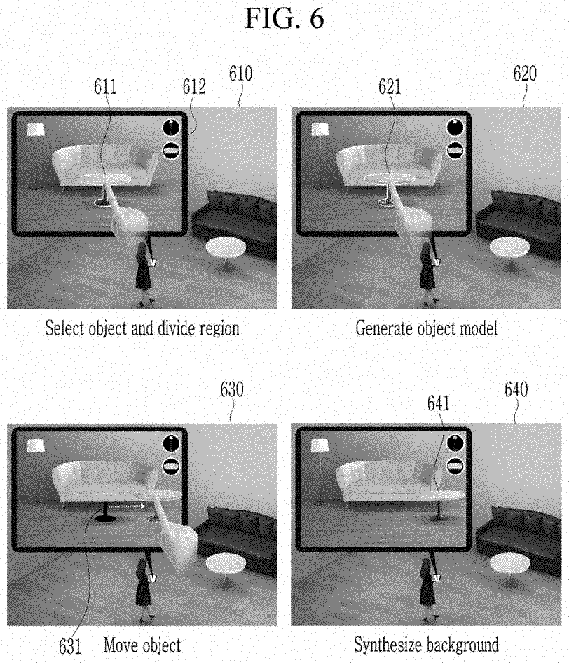

FIG. 6 is a conceptual view for a schematic operation of a real object moving apparatus 100 according to one exemplary embodiment.

Referring to reference numeral 610, in a situation in which a 3D augmented reality 612 is implemented by a computer device (i.e., the environment reconstruction thread unit 110) of the user, the moving object selection unit 120 is selected with a real object 611 to be moved from the user. In addition, the object region division unit 130 divides the moving object input from the moving object selection unit 120 in the 3D augmented reality. Referring to reference numeral 620, the object model generation unit 140 generates a 3D object model 621 for the moving object divided by the object region division unit 130.

Referring to reference numeral 630, when the user drags the moving object, the object movement unit 150 moves the moving object in the augmented reality. In this case, an existing location of the moving object is deleted, and a part deleted in reference numeral 630 is marked with a black 631.

Referring to reference numeral 640, the object region background synthesis unit 170 synthesizes the deleted part by using the surrounding background information of the deleted part. Through this, a real object 641 may be virtually moved in the augmented reality.

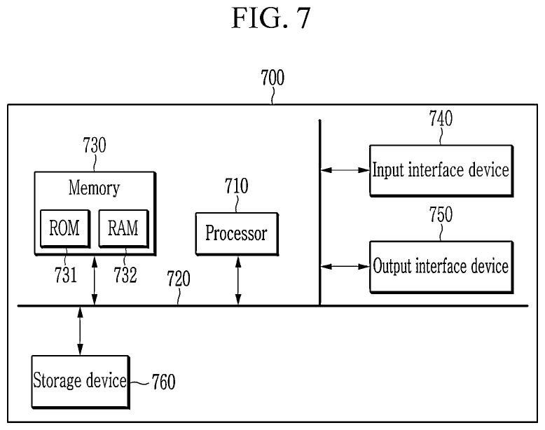

FIG. 7 is a diagram illustrating a computer system 700 according to one exemplary embodiment.

The real object moving apparatus 100 according to the exemplary embodiment may be implemented by a computer system 700 illustrated in FIG.

7. In addition, each component of the real object moving apparatus 100 may be implemented by the computer system 700 illustrated in FIG. 7.

The computer system 700 may include at least one of a processor 710, a memory 730, a user interface input device 740, a user interface output device 750, and a storage device 760 which communicate through a bus 720.

The processor 710 may be a central processing unit (CPU), or a semiconductor device executing a command stored in the memory 730 or the storage device 760. The processor 710 may be configured to implement functions and methods described in FIGS. 1 to 6 above. The memory 730 and the storage device 760 may be various types of volatile or non-volatile storage media. For example, the memory 730 may include a read-only memory (ROM) 731 and a random access memory (RAM) 732. In one exemplary embodiment, the memory 730 may be positioned inside or outside the processor 710 and connected with the processor 730 through various already known means.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method for moving, by an apparatus for moving a real object, the real object in a 3D augmented reality, the method comprising:
dividing a region of the real object in the 3D augmented reality;
generating a 3D object model by using first information corresponding to the region of the real object; and
moving the real object on the 3D augmented reality by using the 3D object model.

2. The method of claim 1, wherein:
the first information is 3D information and texture information corresponding to the region of the real object.

3. The method of claim 2, wherein:
the generating includes, estimating a 3D shape for an invisible region for the real object by using the 3D information, and generating the 3D object model by using the texture information and the 3D shape.

4. The method of claim 1, further comprising:
synthesizing a region at which the real object is positioned before moving by using second information which is surrounding background information for the region of the real object.

5. The method of claim 4, wherein:
the synthesizing includes, deleting the region of the real object in the 3D augmented reality, and performing inpainting for the deleted region by using the second information.

6. The method of claim 5, wherein:
the synthesizing further includes estimating a shade region generated by
the real object, and
the deleting includes deleting the region of the real object and the shade region in the 3D augmented reality.

7. The method of claim 4, wherein:
the second information is 3D information and texture information for a surrounding background for the region of the real object.

8. The method of claim 3, wherein:
the estimating includes estimating the 3D shape by using the 3D information through a deep learning network constituted by an encode and a decode.

9. The method of claim 5, wherein:
the performing of the inpainting includes performing the inpainting for the deleted region by using the second information through a deep learning network constituted by a generator and a discriminator.

10. The method of claim 1, further comprising:
selecting, by a user, the real object to be moved in the 3D augmented reality.

11. An apparatus for moving a real object in a 3D augmented reality, the apparatus comprising:
an environment reconstruction thread unit performing 3D reconstruction of a real environment in for the 3D augmented reality;
a moving object selection unit being input from the user with a moving object which is a real object to be moved from a 3D reconstruction image;
an object region division unit dividing a region corresponding to the moving object in the 3D reconstruction image;
an object model generation unit generating a 3D object model for the divided moving object; and
an object movement unit moving the moving object in the 3D augmented reality by using the 3D object model.

12. The apparatus of claim 11, wherein:
the object model generation unit generates the 3D object model by using 3D information and texture information corresponding to the divided moving object.

13. The apparatus of claim 12, wherein:
the object model generation unit estimates a 3D shape for an invisible region for the moving object by using the 3D information, and generates the 3D object model by using the texture information and the 3D shape.

14. The apparatus of claim 11, further comprising:
an object region background synthesis unit synthesizing a region at which the moving object is positioned before moving by using surrounding background information corresponding to the divided moving object.

15. The apparatus of claim 14, wherein:
the object region background synthesis unit deletes the region corresponding to the moving object, and performs inpainting for the deleted region by using the surrounding background information.

16. The apparatus of claim 15, wherein:
the object region background synthesis unit estimates a shade region generated by the moving object, and deletes the region corresponding to the moving object and the shade region in the 3D augmented reality.

17. The apparatus of claim 15, wherein:
the object region background synthesis unit includes, a generator being input with the 3D reconstruction image including the deleted region, and outputting the inpainted image, and a discriminator discriminating an output of the generator.

18. The apparatus of claim 14, further comprising:
an object rendering unit rendering the 3D object model; and
a synthesis background rendering unit rendering the synthesized region.

19. The apparatus of claim 13, wherein:
the object model generation unit includes 2D encoder being input with the 3D information and outputting a shape feature vector, and a 3D decoder being input with the shape feature vector and outputting the 3D shape.
